(19) United States
(12) Patent Application Publication
(10) Pub. No.: US 2025/0078612 A1
(43) Pub. Date: Mar. 6, 2025

(54) PLAYER IDENTIFICATION BASED ON PLAYER BEHAVIORAL ANALYSIS IN A CASINO ENVIRONMENT

(71) Applicant: IGT, Las Vegas, NV (US)

(72) Inventors: Stefan Keilwert, St. Josef (AT); Michael Russ, Graz (AT); Soheil Latifi, Brampton (CA)

(21) Appl. No.: 18/242,614

(22) Filed: Sep. 6, 2023

(51) Int. Cl. G07F 17/32

(52) U.S. Cl. CPC G07F 17/3239; G07F 17/3223; G07F 17/3227; G07F 17/3255

(57) ABSTRACT

Embodiments of the present disclosure are directed to identifying a player of an electronic game based on gameplay information, a player identification model, player presence data, mobile connectivity data, or any combination therein while maintaining anonymity. According to one embodiment, the present disclosure relates to a method for identifying an anonymous player of an electronic gaming system comprising receiving, by a host system, gameplay information from the electronic gaming system related to an electronic game executed on the electronic gaming system, evaluating, by the host system, the gameplay information based on a player identification model, scoring, by the host system, a probability of identifying the anonymous player based on the evaluating of the gameplay information by the host system, and assigning, by the host system, an identifier based on the scoring by the host system, wherein the identifier identifies the player while maintaining anonymity.

### BACKGROUND

The present disclosure is generally directed to methods, systems, and non-transitory, computer, readable mediums for anonymous identification, in particular, toward identifying anonymous players of an electronic gaming system in a gaming venue, such as a casino, based on activity and/or behavior of the player.

In a casino environment, offering players a tailored experience may increase engagement, which may increase playing time and may encourage customer loyalty. Further, a better playing experience may increase casino revenues. Players, however, may not want to create tracking cards, or provide personal, identifying, information to the casino. Thus, there is a need to identify players while maintaining anonymity.

### BRIEF SUMMARY

Embodiments of the present disclosure are directed to identifying an anonymous player of an electronic game based on gameplay information, a player identification model, player presence data, mobile connectivity data, behavior of the player, and/or any combination therein. According to one embodiment, the present disclosure relates to a method for identifying an anonymous player of an electronic gaming system comprising receiving, by a host system, gameplay information from the electronic gaming system related to an electronic game executed on the electronic gaming system, evaluating, by the host system, the gameplay information based on a player identification model, scoring, by the host system, a probability of identifying the anonymous player based on the evaluating of the gameplay information by the host system, and assigning, by the host system, an identifier based on the scoring by the host system, wherein the identifier identifies the player while maintaining anonymity.

The gameplay information may include the game selection, a sequence of games selected, volume, rumble, 3D intensity, display brightness, a wager, a sequence of wagers, a minimum wager, pay lines, and any other information associated with the electronic game.

Further, the player identifier may be sent to the gaming system. Sending the player identifier to the gaming system may result in a message displayed to the player, a voucher, discount, or promotional credit provided to the player, a recommendation for a different game, a different game executed on a gaming system other than the gaming system occupied by the player, player preferences applied to the gaming system, or any combination therein. The player preferences applied to the gaming system, may include, for example, volume level, screen brightness, rumble intensity, 3D intensity, or any combination therein.

The host system may also receive mobile connectivity data, such as a list of connected devices from a network host. The host system may also receive player presence data, such as gaming venue registration, and gaming venue purchases. The mobile connectivity data and player presence data may be anonymized to protect the player's personal information.

The host system may evaluate the gameplay information, mobile connectivity data, player presence data, individually or as any combination therein. The host system may score a probability of identifying an anonymous player based on the evaluation of the gameplay information, mobile connectivity data, player presence data, individually or as any combination therein.

According to another embodiment, a gaming system may comprise a processor and a memory coupled with and readable by the processor. The memory may store therein a set of instructions which, when executed by the processor causes the processor to receive gameplay information from an electronic gaming system related to an electronic game executed on the electronic gaming system, evaluate the gameplay information based on a player identification model, score a probability of identifying an anonymous player based on the evaluation of the gameplay information, and assign an identifier based on the scoring by the host system, wherein the identifier identifies the player while maintaining anonymity.

The memory may include instructions which, when executed by the processor, cause the processor to assign a player volatility rating based on the gameplay information, player identifier, or both. The gameplay information may include, for example, a wager or series of wagers. The instructions may cause the processor to send a volatility identifier to the electronic gaming system when the volatility rating exceeds a predetermined threshold. The predetermined threshold may be based on, for example, the gameplay information and the player identifier. The result of sending the volatility identifier to the electronic gaming system may comprise an alert issued to the player. The alert may be issued to the player via the gaming system, such as through a message displayed on the gaming system, or may be issued to the player by staff of the gaming venue, or both.

According to yet another embodiment, a non-transitory, computer, readable medium may comprise a set of instructions stored therein which, when executed by a processor, causes the processor to receive gameplay information from an electronic gaming system related to an electronic game executed on the electronic gaming system, evaluate the gameplay information based on a player identification model, score a probability of identifying an anonymous player based on the evaluation of the gameplay information, and assign an identifier based on the scoring by the host system, wherein the identifier identifies the player while maintaining anonymity.

The identifier may uniquely identify the player, such that each player has a distinct identifier. Additionally, or alternatively, the instructions may cause the processor to assign an identifier which identifies the player within predetermined player categories while maintain anonymity. The predetermined player categories may be based on, among other metrics, wager amounts, average time spent playing an electronic game, average time spent at the casino, the number and type of beverages order, or any combination therein.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which player identification while maintaining anonymity according to various embodiments of the present disclosure may be implemented;

FIG. 2 is a flowchart illustrating an exemplary process for identifying an anonymous player of an electronic gaming system according to an embodiment of the present disclosure;

FIG. 3 is a flowchart illustrating an exemplary process for identifying an anonymous player of an electronic gaming system according to another embodiment of the present disclosure;

FIG. 4 is a block diagram of illustrating additional details of components of an exemplary host system according to one embodiment of the present disclosure;

FIG. 5 is a flowchart illustrating a method for updating the settings of an electronic gaming system played by an identified anonymous player according to an embodiment of the present disclosure;

FIG. 6 is a flowchart illustrating a method for executing an electronic game on a gaming system based on identification of an anonymous player of an electronic gaming system according to an embodiment of the present disclosure;

FIG. 7A is a flowchart illustrating a method for alerting an identified anonymous player of an electronic game according to an embodiment of the present disclosure; and

FIG. 7B is a flowchart illustrating a method for alerting an identified anonymous player of an electronic game according to an embodiment of the present disclosure.

### DETAILED DESCRIPTION

Embodiments of the present disclosure are directed to identifying an anonymous player of an electronic game according to, for example, player behavior indicated in collected gameplay information and a player identification model. Various embodiments described herein provide for identification without requiring a player's personal information or a player tracking card. Embodiments allow for unique, or individual, player identification, identification of a player type within predetermined categories or types, or both. Embodiments may vary based on what inputs are considered by the host system in identifying the player, what results from the anonymous player identification, and where data from the player identification is stored.

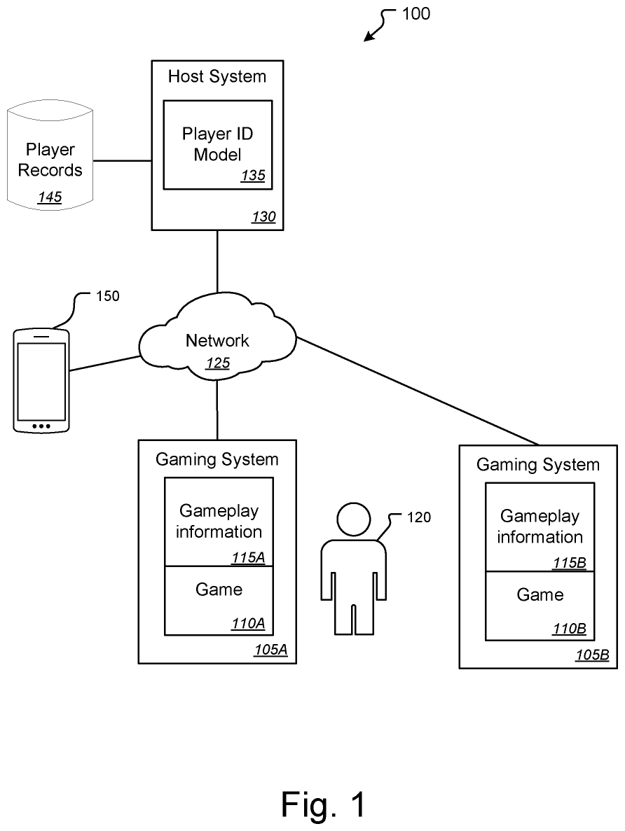

FIG. 1 is a block diagram illustrating an exemplary environment 100 in which anonymous player identification according to various embodiments of the present disclosure may be implemented. As illustrated in FIG. 1, the environment 100, such as may be found in a casino or other gaming venue, may have a host system 130. The host system 130 may comprise any one or more servers and/or other computing devices adapted to support gaming activities within the gaming venue in which a gaming system 105, such as an Electronic Gaming Machine (EGM) or similar system is installed.

As illustrated in FIG. 1, the host system 130 may be coupled with the gaming system 105 through a communications network 125. The communications network 125 may comprise any one or more wired and/or wireless, local area and/or wide area networks as known in the art including, but not limited to, the Internet. Through the communications network 125, the host system 130 may receive gameplay information 115 from the gaming system 105. By evaluating the gameplay information 115 based on the player identification model 135, the host system 130 may identify a player 120 of an electronic game 110 executed on the gaming system 105 while maintaining anonymity.

Additionally, the environment 100 may include a mobile device 150, such as smartphone, connected to the network 125. Accordingly, the host system 130 may receive mobile device information, such as the device name and model. The mobile device information may be used to identify a player 120 while maintaining anonymity.

Additionally, the environment 100 may include a second gaming system 105B. It is appreciated that the environment 100 may comprise more than two gaming systems without departing from the scope of this disclosure.

The host system 130 may be coupled with both the first gaming system 105A and second gaming system 105B through a communications network 125. The communications network 125 may comprise any one or more wired and/or wireless, local area and/or wide area networks as known in the art including, but not limited to, the Internet. Through the communications network 125, the host system 130 may receive gameplay information 115A and 115B from the first gaming system 105A and second gaming system 105B. By evaluating the gameplay information 115A from the first gaming system 105A based on the player identification model 135, the host system 130 may identify a player 120 of an electronic game 110A executed on the first gaming system 105A while maintaining anonymity. The result of the player identification by the host system 130 may include an electronic game 110B executed on the second gaming system 105B based on player preferences in the player identification model 135. Accordingly, when the player 120 finishes playing the game 110A on the first gaming system 105A, they may have a preferable game 110B available to them on the second gaming system 105B.

The host system 130 may be further connected to a player records database 145 wherein the player records database 145 may store data evaluated by the host system 130. For example, in some embodiments, the player records database 145 may include gameplay information 145, wherein the gameplay information may be accessed by, or distributed to, a manufacturer of a gaming system 105 to improve the game 110 or develop new games. Doing so may increase player engagement while preserving player anonymity. In some embodiments, the player records 145 may be accessed by, or distributed to, the gaming system operator, such as a casino. A gaming system 105 operator may utilize the player records 145 to increase player engagement, by for example, modifying the arrangement of gaming systems, modifying threshold wager amounts, modifying the frequency at which casino staff interact with players, or any combination therein, based on identification of an individual player or player type yet while maintaining player anonymity. In addition to, or separately from, increasing player engagement, the present disclosure may support law enforcement. For example, in some embodiments, the player identification model 135, player records 145, or both, may be shared with law enforcement officials to help identify criminal activities, such as money laundering. Additionally, or alternatively, player identification according to embodiments described herein can be used to implement various responsible gaming features and/or functions.

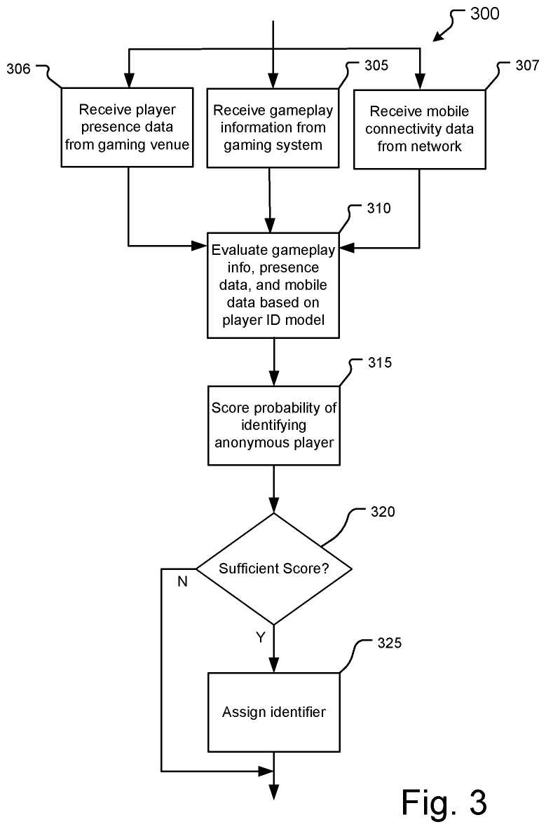

Further, while FIG. 1 illustrates an environment 100 with a mobile device 150, a first gaming system 105A, and a second gaming system 105B, it is appreciated that embodiments of the present disclosure can be implemented without utilizing inputs from a second gaming system 105B or from a mobile device 150. Also, embodiments disclosed herein can include additional inputs, such as player presence data as discussed, for example, relative to FIG. 3.

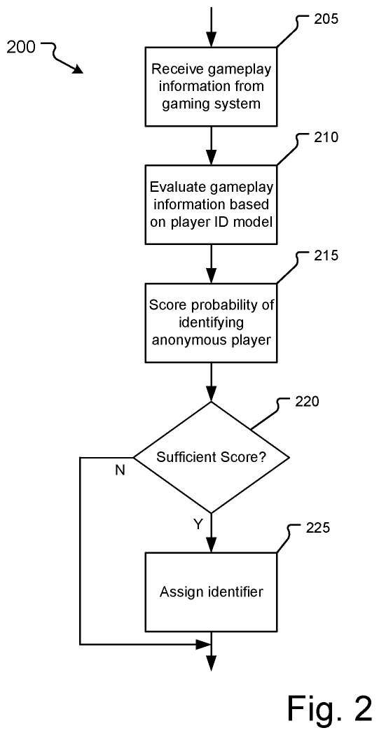

FIG. 2 illustrates an exemplary process 200 for identifying a player 120 according to an embodiment of the present disclosure. As illustrated in this example, identifying the player 120 may comprise receiving 205 gameplay information 115A from a gaming system 105A. The gameplay information 115A may comprise, for example, the game selection, a sequence of game selections, the cash in amount, the wager amount, a sequence of wagers, the number of payout lines, volume, rumble, 3D intensity, screen brightness, or any combination therein.

Identifying an anonymous player 120 can further comprise evaluating 210 the gameplay information 115A based on a player identification model 135. The player identification model 135 may include, for example, correlations between gameplay information 115A and anonymous player identifiers.

Identifying an anonymous player 120 can further comprise scoring 215 a probability of identifying the anonymous player, and assigning 225 an identifier to the anonymous player 120. Scoring 215 the probability of identifying the anonymous player based on the evaluation 210 of the gameplay information may result in assigning 225 an existing identifier from the player identification model, or a new identifier, corresponding to an anonymous player 120. In some embodiments, scoring 215 the probability of identifying the anonymous player 120 may alternatively, or additionally, result in assigning 225 a player-type identifier, which identifies a category of players based on predetermined categories from the player identification model. The predetermined categories may be based on, among other metrics, wager amounts, average time spent playing an electronic game, average time spent at the casino, the number and type of beverages ordered, or any combination therein.

In some embodiments, the assignment 225 of an identifier may be based on determining 220 whether the scoring 215 results in a sufficient score. For example, if scoring 215 the probability of identifying an anonymous player results in a score greater than a predetermined confidence threshold for identifying an individual anonymous player, the host system 130 may assign 225 an existing individual identifier to the anonymous player 120. Further, if scoring 215 the probability of identifying an anonymous player 120 results in a score that is less than a predetermined confidence threshold for identifying an individual anonymous player 120, the host system 130 may assign 225 a new individual identifier to the anonymous player 120, and update the player identification model 135. Further, if scoring 215 the probability of identifying an anonymous player results in a score that is greater than a predetermined confidence threshold for identifying a category of player, or player-type, the host system 130 may assign 225 an existing player category identifier to the anonymous player 120. It is appreciated that in various embodiments “greater than” or “less than” may be implemented as “greater than or equal to” or “less than or equal to” without departing from the scope of this disclosure.

The predetermined confidence threshold for identifying an individual player, and the predetermined confidence threshold for identifying a player-type may be based on, among other considerations, the preference of the gaming venue operator, preference of the gaming system operator, prior player identification, or any combination therein. For example, in some embodiments each existing player identifier in the player identification database may have an respective confidence threshold based on the number of times the player identifier has been assigned 225.

Scoring 215 the probability of identifying an anonymous player 120 may be based on the evaluation 210 of gameplay information 115A. For example, in some embodiments, evaluating 210 the gameplay information 115A may include comparing gameplay information from the gaming system 105A with gameplay information correlated to player identifiers in the player identification model 135. Further, scoring 215 the probability of identifying an anonymous player 120 may include determining the likelihood that gameplay information 115A from the gaming system 105A and corresponding data in the player identification model 135 identify an anonymous player 120. For example, in some embodiments a variance may be assumed for a type of gameplay information 115A, such as the wager amount. Based on the assumed variances, the host system 130 may compute a confidence value. In some embodiments, a confidence value may be computed based on the aggregate of the gameplay information 115A considered by the host system 130. For example, the occurrence of multiple types of gameplay information 115A, such as a particular wager, a particular game selection, and a particular volume, may be uniquely associated with an anonymous player 120.

Further, in some embodiments, weights may be assigned to each type of gameplay information 115A, combinations of gameplay information, or both. For example, the sequence of games selected may contribute less to scoring 215 the probability of identifying an anonymous player 120 than the sequence of wagers placed. By applying weights to the confidence values, the host system 130 may score 215 the probability of identifying an anonymous player 120. In some embodiments, scoring 215 a probability of identifying an anonymous player 120 may include adjusted variances, adjusted confidence values, adjusted weights, or any combination therein, based on prior identification, preference of the gaming venue, or both. For example, the brightness of a gaming system 105A display may be weighed more heavily for existing player identifiers associated with minimal variance in display brightness.

While FIG. 2 illustrates a process 200 wherein a player 120 is identified based evaluation 210 of gameplay information 115A, some embodiments may include additional inputs, such as mobile phone connectivity, wearable connectivity, gaming venue registration, gaming venue credit card payments, or any combination therein, for evaluation based on the player identification model 135.

For example, FIG. 3 illustrates a process 300 for identifying a player 120 according to an embodiment of the present disclosure. The process 300 may include receiving 305 gameplay information 115A from a gaming system 105A, receiving 306 player presence data from a gaming venue, and/or receiving 307 mobile connectivity data from a network 125. Receiving 306 player presence data may include, for example, receiving gaming venue registration information and gaming venue restaurant payments. Receiving 307 mobile connectivity data from the network 125 may include, for example, receiving a list of mobile devices, including device names, that are connected to the network. To preserve the player's 120 anonymity, player presence data and/or mobile connectivity data may be anonymized by the host system 130 so a player's 120 personal information is not in the player records 145 or player identification model 135.

Further, the process 300 may include evaluating 310 the gameplay information 115A, player presence data, and mobile connectivity data based on the player identification model 135. A probability of identifying an anonymous player 120 may be scored 315 based on the evaluation 310. After scoring 315 a probability of identifying an anonymous player, an identifier may be assigned 325 wherein a player 120 is identified while maintaining anonymity. The assignment 325 may depend on a determination 320 of whether the scoring 315 results in a sufficient score, as previously discussed.

In some embodiments, the evaluation 310 may include comparing the received 305 gameplay information 115A, the received 306 player presence data, and the received 307 mobile connectivity data with a player identification model 135. For example, the player identification model 135 may include a correlation between the connection of an anonymized mobile device 150 to the network 124 and a sequence of game selections. As another example, the player identification model 135 may include a correlation between an anonymized registration at the gaming venue, an anonymized mobile device 150 being connected to the network 125, and a minimum wager placed on a game 110A.

Further, based on the evaluation 310, a probability of identifying an anonymous player, player-type, or both, may be scored 315. As discussed above, scoring 315 may include, for example, assigning weights to each input and applying assumed variances to measure the similarity between the received 305, 306, and 307 inputs and the corresponding data in the player identification model 135. Based on the scoring 315, an identifier may be assigned to an anonymous player 120. As discussed above, the assignment 320 may depend on whether the scoring 315 returns a value above or below a predetermined threshold.

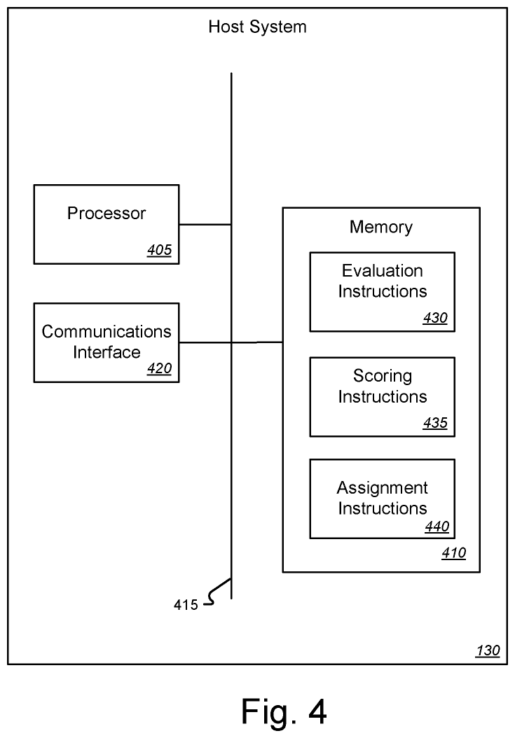

The exemplary processes 200, 300 discussed above may take place on a host system 130. FIG. 4 is a block diagram illustrating additional details of components of an exemplary player identification system including a host system 130 according to an embodiment of the present disclosure. As illustrated in this example, a host system 130 may comprise a processor 405. The processor 405 may correspond to one or many computer processing devices. For instance, the processor 405 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 405 may be provided as a microprocessor, Central Processing Unit (CPU), or plurality of microprocessors that are configured to execute the instructions sets stored in a memory 410. Upon executing the instruction sets stored in memory 410, the processor 405 enables various functions of the host system 430 as described herein.

The memory 410 may be coupled with and readable by the processor 405 via a communications bus 415. The memory 410 may include any type of computer memory device or collection of computer memory devices. Non-limiting examples of memory 410 include Random Access Memory (RAM), Read Only Memory (ROM), flash memory, Electronically-Erasable Programmable ROM (EEPROM), Dynamic RAM (DRAM), etc. The memory 410 may be configured to store the instruction sets depicted in addition to temporarily storing data for the processor 405 to execute various types of routines or functions.

The processor 405 may also be coupled with one or more communication interfaces 420 via the communications bus 415. The communication interfaces 420 may comprise, for example, a Bluetooth, WiFi, cellular, and/or other type of wireless communications interface.

The memory 410 may store therein a set of evaluation instructions 430 which, when executed by the processor 405, cause the processor 405 to evaluate gameplay information 115 based on a player identification model 135. The memory 410 may also store therein a set of scoring instructions 435 which, when executed by the processor 405, cause the processor 405 to score a probability of identifying an anonymous player 120 based on the evaluation of the gameplay information 115. The memory 410 may also store therein a set of assignment instructions 440 which, when executed by the processor 405, cause the processor 405 to assign an identifier to the anonymous player 120, wherein the identifier identifies the player 120 while maintaining anonymity.

In some embodiments, once the player 120 is identified by the host system 130, additional actions may be executed by the host system 130 to increase engagement and provide valuable data to operators and manufacturers while maintaining anonymity. In some exemplary embodiments, assignment of the player identifier may result in updated gameplay settings, such as volume, rumble intensity, 3D intensity, and display brightness, based on preferences associated with the player identifier. In additional exemplary embodiments, assignment of the player identifier may result in a gift voucher, discount, or promotional credits, to a gaming venue. The anonymous player 120 may be determined to qualify for such a gift voucher, discount, or promotion credit based on, among other metrics, the number of times the player visited the casino, the frequency of that player's visits, the amount of money spent by the player on a game, the amount of money spent by the player in the gaming venue, or any combination therein. In additional exemplary embodiments, assignment of the player identifier may result in tailored interactions between the gaming venue staff and the player. Such tailored interactions may include, for example, the player being served their preferred drink.

In additional exemplary embodiments, assignment of the player identifier may result in a unique message displayed to the anonymous player 120 on the gaming system 105A. The unique message may include, among other messages, the number of jackpots the player 120 has won in the game, the number of jackpots the player 120 has won at the gaming venue, the player's win percentage for the game 110A over a predetermined period, the number of times the player 120 has played the game 110A during a predetermined period, the total money the player 120 has won playing at the gaming venue during a predetermined period, the player's 120 average wager for the game 110A during a predetermined period, a game recommendation for the player to play a different game, and any combination therein.

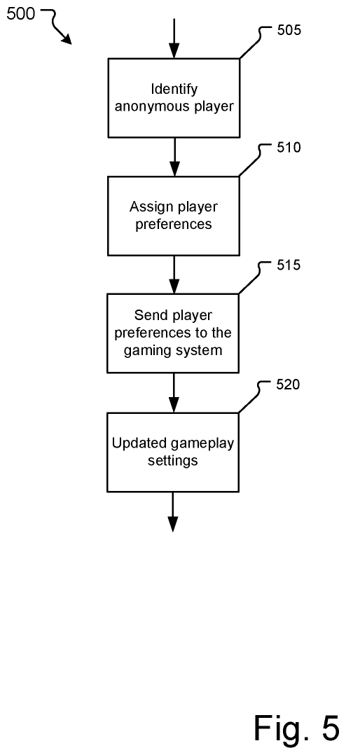

For example, FIG. 5 illustrates a process 500, according to an embodiment of the present disclosure, which may result in updated 520 gameplay settings after identifying 505 an anonymous player 120. The anonymous player 120 may be identified 505 according to various embodiments disclosed herein. After identifying 505 an anonymous player 120, player preferences may be assigned 510 based on the identification 505 of the anonymous player, and the player preferences may be sent 515 to the gaming system 105A, wherein the result of sending 515 the player preferences to the gaming system 105A comprises updated 520 gameplay settings on the gaming system 105A. In some embodiments, the host system 130 may interface with multiple gaming systems by, for example, updating the electronic game 110B executed on a gaming system 105B near the anonymous player 120 to increase engagement.

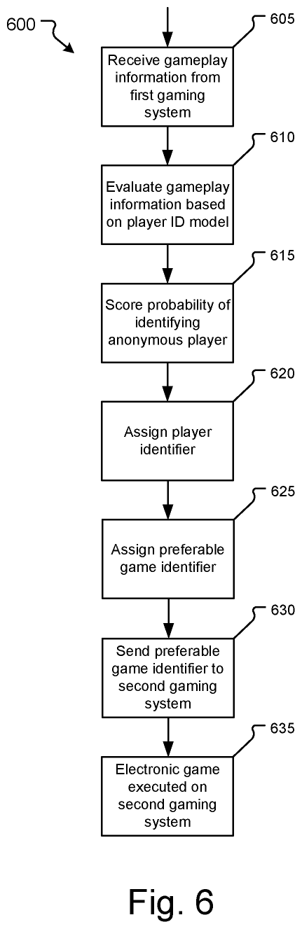

For example, FIG. 6 illustrates an exemplary process 600 for identifying an anonymous player 120 of an electronic game 110A played on a first gaming system 105A according to embodiments of the present disclosure, wherein an electronic game 110B may be executed on a second gaming system 105B as a result of the player identification. As illustrated in FIG. 6, after receiving 605 gameplay information 115A from the first gaming system 105A, the gameplay information 115A may be evaluated 610 based on a player identification model 135. Following evaluation 610, a probability of identifying an anonymous player may be scored 615. Based on the score 615, a player identifier may be assigned 620 which identifies a player 120 while maintaining anonymity. The player identifier assignment 620 may depend on whether the scoring 615 results in a sufficient score, as previously discussed. While FIG. 6 illustrates gameplay information 115A as the input to the process 605, additional inputs, such as player presence data and mobile connectivity data may be evaluated 610 and may contribute to scoring 615 the probability of identifying an anonymous player, as discussed above.

Based on the assigned 620 player identifier and the player records 145, a preferable game, other than the game 110A currently being played by the player 120, may be determined and a corresponding preferable game identifier may be assigned 625 to the anonymous player 120. Assigning 625 a preferable game identifier may be based on, for example, data indicating time spent playing individual games in the gaming venue, the identified player's 120 most common sequence of games, or both. For example, if the player records 145 indicate that the identified player 120 most frequently plays a particular subsequent game after exiting the current game they are playing, the preferable game identifier may correspond to that subsequent game. It is appreciated that the subsequent, or second, game is relative to the game the player 120 is currently playing such that the player may be playing, for example, their fifth game that day, and the sixth game may be recommended as described above.

The preferable game identifier may be sent 630 to a second gaming system 105B, wherein the result of sending 630 the preferable game identifier may be that the game corresponding to the preferable game identifier is executed 635 on the second gaming system 105B. While FIG. 6 illustrates a process including a second gaming system 105B, it is appreciated that a similar process may be implemented wherein the preferable game identifier is sent to the first gaming system 105A without departing from the scope of this disclosure. For example, sending the preferable game identifier to the first gaming system 105A may result in the player receiving a recommendation for the preferable game, as discussed above. The recommendation may be, for example, a message displayed on the gaming system 105A. Providing a recommended game, either on the gaming system 105A currently used by the player 120 or a different gaming system 105B, may increase engagement by providing the player 120 with easier access to games they enjoy playing.

In further embodiments, the anonymous identification of the player 120, as disclosed herein, may facilitate responsible gaming, which may improve customer loyalty.

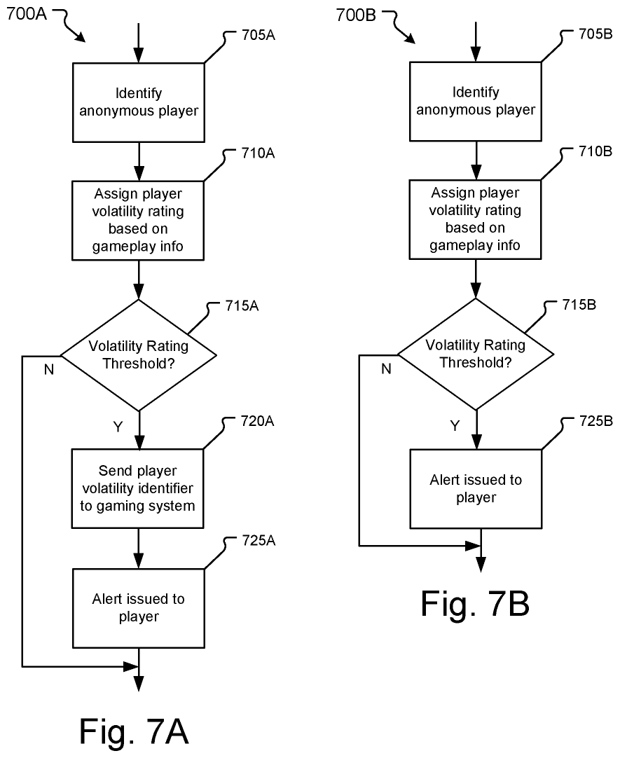

For example, FIG. 7A illustrates a process 700A according to an embodiment of the present disclosure which may result in an alert issued 725A to the player 120 if their behavior is determined to be too volatile, or problematic. Namely, a volatility rating may be assigned 710A based on, among other metrics, the player identifier, the gameplay information 115A, or any combination therein. Accordingly, the assignment 710A of the volatility rating may be tailored to a player or player-type, such that the volatility rating may reflect whether a player's 120 behavior is too volatile or problematic relative to their typical behavior. Further, the volatility rating may be compared 715A to a predetermined volatility rating threshold.

In some embodiments, the volatility rating may be assigned 710A independently of the player identification, such that a player's 120 typical behavior might not be considered in assigning 710A the volatility rating. In such embodiments, the predetermined volatility rating threshold may be tailored to individual players, player-types, or both. The predetermined volatility rating threshold may be based on, among other metrics, the gameplay information 115A, the player identifier, or any combination therein. The volatility rating and predetermined volatility rating threshold may be based on gameplay information 115A including, for example, a wager, prior wagers for the anonymous player 120 corresponding to the electronic game 110A or a different electronic game, time spent by the anonymous player 120 playing the electronic game 110A, win/loss data for the anonymous player 120 concerning the electronic game 110A, win/loss data for the anonymous player 120 concerning a different electronic game, or any combination therein.

If the volatility rating exceeds the volatility rating threshold, a volatility identifier may be sent 720A to the gaming system 105A. Further, the result of sending 720A the volatility identifier to the gaming system 105A may be an alert issued 725A to the player 120. The alert issued 725A may be, for example, a message displayed on the gaming system 105A, an aural message from the gaming system 105A, a temporary lockout timer displayed on the gaming system 105A, or any combination therein. Further, the alert may be part of a series of alerts, wherein, for example, the type of alert may change between successive occurrences of the volatility rating exceeding the volatility threshold. In some embodiments, an alert may be issued to the player 120 without sending the volatility identifier to the gaming system 105A.

For example, FIG. 7B illustrates a process 700B according to an embodiment of the present disclosure wherein an alert may be issued 725B to an anonymous player 120 if their behavior is determined to be too volatile, or problematic. Namely, after identifying 705B the anonymous player 120, a volatility rating may be assigned 710B based on gameplay information 115A. Further, the volatility rating may be compared 715B to a predetermined volatility rating threshold, wherein if the volatility rating exceeds the predetermined volatility rating threshold, an alert may be issued 725B to the anonymous player 120. The alert issued 725B to the player 120 may comprise, for example, a verbal warning from staff of the gaming venue.

Ultimately, the embodiments disclosed herein identify a player 120 of an electronic game 110A while maintaining anonymity. Doing so may improve the player's 120 experience by offering a tailored experience, recommended games, and protection from volatile or problematic behavior.

A number of variations and modifications of the disclosure may be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PUP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for identifying an anonymous player of an electronic gaming system, the method comprising:
receiving, by a host system, gameplay information from the electronic gaming system related to an electronic game executed on the electronic gaming system;
evaluating, by the host system, the gameplay information based on a player identification model;
scoring, by the host system, a probability of identifying the anonymous player based on the evaluating of the gameplay information by the host system; and
assigning, by the host system, an identifier based on the scoring by the host system, wherein the identifier identifies the player while maintaining anonymity.

2. The method of claim 1, wherein the gameplay information includes a selection of an electronic game by the anonymous player on the electronic gaming system.

3. The method of claim 1, further comprising:
sending, by the host system, the player identifier to the electronic gaming system.

4. The method of claim 3, wherein the result of sending, by the host system, the player identifier to the electronic gaming system is a message displayed to the player.

5. The method of claim 3, wherein the result of sending, by the host system, the player identifier to the electronic gaming system comprises a voucher for a gaming venue.

6. The method of claim 3, wherein the result of sending, by the host system, the identifier to the electronic gaming system comprises a credit for an electronic game.

7. The method of claim 3, wherein the result of sending, by the host system, the identifier to the electronic gaming system comprises an electronic game recommendation.

8. The method of claim 1, further comprising:
assigning, by the host system, player preferences based on the player identifier; and
sending, by the host system, the player preferences;
wherein the result of sending, by the host system, the player preferences, comprises updated gameplay settings for the electronic game.

9. The method of claim 8, wherein the player preferences include volume level, screen brightness, and rumble intensity.

10. The method of claim 1, further comprising:
sending, by the host system, the player identifier to a second electronic gaming system;
wherein the result of sending, by the host system, the player identifier to the second electronic gaming system comprises an electronic game executed on the second gaming system based on the player identifier.

11. The method of claim 1, further comprising:
receiving, by the host system, a list of connected devices from a network host; and
evaluating, by the host system, the list of connected devices based on the player identification model, wherein the scoring by the host system is based on the evaluating of the gameplay information and the evaluating of the list of connected devices by the host system.

12. A player identification system comprising:
a processor; and
a memory coupled with and readable by the processor and storing therein a set of instructions which, when executed by the processor, causes the processor to:
receive gameplay information from an electronic gaming system related to an electronic game executed on the electronic gaming system;
evaluate the gameplay information based on a player identification model;
score a probability of identifying an anonymous player based on the evaluation of the gameplay information; and
assign an identifier based on the scoring by the host system, wherein the identifier identifies the player while maintaining anonymity.

13. The system of claim 12, wherein the processor further:
assigns a player volatility rating based on the gameplay information; and
sends a volatility identifier to the electronic gaming system when the player volatility rating exceeds a predetermined threshold.

14. The system of claim 13, wherein the gameplay information comprises a wager.

15. The system of claim 13, wherein predetermined threshold is based on the gameplay information and the player identifier.

16. The system of claim 13, wherein the result of sending the volatility identifier to the electronic gaming system comprises an alert.

17. A non-transitory, computer, readable medium comprising a set of instructions stored therein which, when executed by a processor, causes the processor to:
receive gameplay information from an electronic gaming system related to an electronic game executed on the electronic gaming system;
evaluate the gameplay information based on a player identification model;
score a probability of identifying an anonymous player based on the evaluation of the gameplay information; and
assign an identifier based on the scoring by the host system, wherein the identifier identifies the player while maintaining anonymity.

18. The non-transitory, computer, readable medium of claim 17, wherein the identifier uniquely identifies the player.

19. The non-transitory, computer, readable medium of claim 17, wherein the identifier identifies the player within predetermined player categories.

20. The non-transitory, computer readable medium of claim 18, wherein the predetermined player categories are based on wager amounts.
